(19) United States
(12) Patent Application Publication
(10) Pub. No.: US 2006/0003239 A1
(43) Pub. Date: Jan. 5, 2006

(54) Multilayer optical display device

(76) Inventors: Terence Alfred Cooper, Newark, DE (US); Kenji Yoshida, Tokyo (JP)

Correspondence Address: JAMES MAGEE, JR., 30 CANTERBURY RD., CLIFTON PARK, NY, 12065, US

(21) Appl. No.: 10/882,989

(22) Filed: Jun. 30, 2004

(51) Int. Cl. G02F 1/03

(52) U.S. Cl. 430/20

(57) ABSTRACT

A multilayer optical device which comprises one or more radiation scattering layers, radiation absorption layers, tint layers, interfacial layers, adhesive layers, protective layers, matte, non-reflective, anti-glare, antistatic or embossed surface layers, focusing layers and supporting layers is described. Interfacial layers, adhesive layers, protective layers, tint layers, matte, non-reflective, anti-glare, antistatic or embossed surface layers, focusing layers and supporting layers may be optional in some embodiments of the invention. The device is used to display an image which is projected either in the transmission or reflection mode.

### FIELD OF THE INVENTION

The invention relates to multilayer optical devices which comprises one or more thermoplastic or thermoset polymer layers which function as radiation scattering layers, radiation absorption layers, tint layers, interfacial layers, adhesive layers, protective layers, matte, non-reflective, anti-glare, antistatic or embossed surface layers, focusing layers and supporting layers is described. Interfacial layers, adhesive layers, protective layers, tint layers, matte, non-reflective, anti-glare, antistatic or embossed surface layers, focusing layers and supporting layers may be optional in some embodiments of the invention. The device is used to display an image which is projected either in the transmission or reflection mode.

### BACKGROUND OF THE INVENTION

Recent advances in projection television, interactive whiteboards, digital signage and other display technologies have led to the need for the development of increasingly large display screens in both the transmission and reflection modes. High performance rear projection screens require balanced characteristics of resolution, gain, contrast and wide viewing angle. The screen must provide sufficient resolution to display sharp images for both video and data presentation and must, at the same time, cause diffusion of the light in such a way as to provide a wide viewing audience angle while still providing high brightness and high contrast, particularly for viewing in the presence of ambient light. A gray or black tint is generally incorporated in monolayer diffusion screens to provide this required contrast.

However, there is still a need for the development of improved inexpensive and efficient front- and rear-projection screens with desirable combinations of the above light-scattering and transmission properties. This need is now addressed by the multilayer optical device of the present invention.

Monolayer diffuser sheets comprising a matrix polymer, often based on polymethyl methacrylate or polycarbonate polymers, and containing a dispersion of light scattering centers with a controlled refractive index differential between the matrix and the light-scattering centers are well known in the art. For example, U.S. Pat. No. 4,165,153 discloses a translucent screen comprising a dispersion of particles with a low index of refraction, such as polytetrafluoroethylene or vinylidene fluoride/tetrafluoroethylene copolymers, in a continuous polymeric matrix with a higher index of refraction such as poly(ethylene/maleic anhydride) and its half esters, polyvinyl butyral or polymethyl cellulose which can also incorporate a small amount of a light absorbing material such as carbon black to provide contrast. As a further example, U.S. Pat. Nos. 5,237,004 and 5,346,954 disclose light diffusing polymer compositions comprising a matrix polymer such as polymethyl methacrylate in which is distributed substantially spherical core-shell particles, with an average diameter ranging from about 2 microns to 15 microns, which contain a core of a rubbery alkyl acrylate polymer or copolymer with an alkyl methacrylate or styrenic monomer and one or more outer shells wherein the outermost shell is compatible with the matrix polymer. The core-shell particles are specified to have a refractive index within about 0.05 units but no closer than about 0.003 units relative to the refractive index of the matrix polymer. Similarly, U.S. Patent Application No. 2004006645 discloses a bulk diffuser material comprising a polycarbonate matrix with scattering centers comprising polyacrylates, polyalkylmethacrylates, polytetrafluoroethylene, silicones, various inorganic materials and mixtures thereof. However, it is our experience that these monolayer bulk diffusers as described in the art do not simultaneously provide an optimum combination of brightness, angle of view, contrast and resolution for use in large display screens such as for projection television, interactive whiteboards, and digital signage.

Bilayer optical devices are also known in the art. For example, U.S. Pat. Nos. 2,180,113 and 2,287,556 describe translucent screens composed of one transparent polymeric layer and second layer composed of discrete particles as a discontinuous phase dispersed throughout a continuous layer of the same material as the first layer, such as particles of polybenzylcellulose dispersed in polyethylcellulose. As a further example, U.S. Pat. No. 5,307,205 discloses a bilayer sheet constructed of a supporting clear polymeric, preferably thermoplastic, layer such as polymethyl methacrylate, and a second polymeric layer, preferably composed of a thermoplastic such as polymethyl methacrylate and preferably also tinted, containing specific, substantially spherical, light diffusing particles. These particles are composed of rubbery alkyl acrylate polymers, such as polybutyl acrylate, or copolymers such as alkyl acrylate/styrene copolymers or else are core-shell particles where the rubbery alkyl acrylate polymer or copolymer is surrounded by one or more shells wherein the outermost shell is compatible with the matrix polymer. Such bilayer optical devices are claimed to provide a good balance of wide viewing angle, resolution, gain and contrast when used for rear projection screens. However, our experience with devices of this type is that, similarly to the case of monolayer and tinted monolayer devices, in order to obtain wide viewing angle, either the concentration of the diffuser particles or the thickness of the tinted diffuser sheet must be increased, which leads to a decreased resolution and lower gain (brightness). Furthermore, in order to obtain high contrast the concentration of the tint component must be increased with a resulting decrease in gain and brightness. In devices of this type and in monolayer devices we have additionally found that incorporation of the contrast tint medium in the same matrix as the diffuser particles also reduces the blackness of the screen device under ambient light and the presence of multiple scattering pathways in the diffuser layer causes a whitening effect and decreases the effectiveness of the tint agent, thereby requiring an even higher concentration of this agent and leading to reduced brightness.

### SUMMARY OF INVENTION

Surprisingly, we have now further found that, by separating the contrast tint from the diffuser particles by placing the diffuser particles in a diffusion layer and the contrast tint in a separate tint layer joined to and/or in contact with the diffuser layer, the viewing angle and resolution can be separately controlled from the brightness and contrast, leading to the production of markedly improved display screens systems suitable for large projection television and other large screen applications.

The multilayer optical display device of this invention comprises one or more radiation, preferably visible spectrum, scattering layers and radiation absorption layers, and optionally one or more interfacial layers, adhesive layers, protective layers, anti-glare layers, anti-reflection layers, antistatic layers, light focusing or light angle modification layers, and supporting layers. The device is used to display an image of light projected either in the transmission or reflection mode. The degree and type of scattering in the scattering layer(s) is controlled by the composition and processing of the polymeric materials used. Similarly, the magnitude and frequency characteristics of the absorption of the absorption layer(s) is controlled by the compositions and processing methods used. The device may be produced by lamination, co-extrusion, solvent bonding, plastics welding, (co)molding, in situ polymerization such as by ultra-violet or other radiation curing or heat curing techniques, or other suitable fabrication methods which provide a multilayer structure. The shape of the initially-produced multilayer structure can be subsequently modified and constrained by standard forming methods such as thermoforming and/or by mounting it into a frame which holds it in a particular shape.

The invention comprises a multilayer optical device for the visualization of projected light images by transmission or reflection which comprises one or more light-scattering layers, one or more light absorption layers, and a reflection layer when the device is used in the reflection mode, each layer having a thermoplastic or thermoset matrix, and, optionally, one or more interfacial layers, adhesive layers, protective layers, matte, non-reflective, anti-glare, antistatic or embossed surface layers, focusing layers such as Fresnel, lenticular or other prism structures, and supporting layers. The scattering layer or layers may comprise one or more types of thermoplastic film or sheet and the degree and type of scattering in the scattering layers are controlled by the composition, thickness and method of processing of the thermoplastic film or sheet which comprises these layers. Absorption layers may comprise one or more types of thermoplastic film or sheet and the degree and type of absorption in the absorption layers are controlled by the composition, thickness and method of processing of the thermoplastic film or sheet which comprises these layers.

The layers can be bonded together by a lamination process, a solvent welding process, a plastics welding process, a molding process, an injection molding process, a co-injection molding process, or any other process which leads to a bilayer or multilayer structure. The scattering and absorbing layers and optionally other layers can also be coextruded to form the multilayer structure. The scattering, absorbing layers, and optionally other layers, can also be produced by in situ polymerization, by ultra-violet or other radiation curing, or heat curing, to form the multilayer structure.

The thermoplastic matrices used for the scattering and absorbing layers can be based, for example, on polymethyl methacrylate, polystyrene, methacrylate copolymers, styrenic copolymers, polycarbonates, polysulfones, cyclic polyolefins, or polymethyl pentene polymers. The scattering layer includes or contains preformed thermoplastic or thermoset particles which control light scattering. The particles which control scattering can be preformed polymeric particles, crosslinked polymeric particles or core-shell particles, or preformed discrete immiscible glass, mineral, or ceramic particles such as silica. The absorbent layer contains a carbon black pigment or other pigment, or a soluble dye such as a soluble black dye.

### DETAILED DESCRIPTION OF THE INVENTION

This invention relates to a multilayer optical device consisting of at least one light scattering layer, at least one light absorption layer, and optionally one or more interfacial layers, adhesive layers, protective layers, anti-glare layers, anti-reflection layers, antistatic layers, light focusing or light angle modification layers, and supporting layers as needed. This device is used to display an image which is projected either in the transmission or reflection mode.

This present invention further relates to a multilayer optical device whereby simultaneous combinations of high transmission gain (or brightness) can be obtained with high contrast, high resolution and a wide viewing angle. This wide viewing angle is measured in terms of a high light-scattering half angle, i.e. the angle from the normal angle to the surface at which the transmission is half that at the normal angle.

An object of the present invention is further to provide a multilayer optical device as described above which provides screens having substantially no grain, showing little or no scintillation and substantially no hot spots or areas of excessive brilliance while diffusing the transmitted light over a wide area.

One embodiment of the present invention is a multilayer optical device for the visualization of projected light images by transmission which comprises at least one scattering layer and at least one absorption layer, and optionally one or more interfacial layers, adhesive layers, protective layers, anti-glare layers, anti-reflection layers, antistatic layers, light focusing or light angle modification layers, and supporting layers.

Another embodiment of this present invention is a multilayer optical device for the visualization of projected light images by reflection which comprises a reflection layer, at least one scattering layer, at least one absorption layer, and optionally one or more interfacial layers, adhesive layers, protective layers, anti-glare layers, anti-reflection layers, antistatic layers, light focusing or light angle modification layers, and supporting layers.

At least one layer of the device is a scattering layer which comprises a polymeric material, preferably an amorphous thermoplastic resin, containing scattering particles which provide the desired light scattering or diffusion properties when incorporated into the multilayer optical device.

The preferably-amorphous thermoplastic resin should have a heat distortion temperature of at least about 70° C., preferably at least about 80° C., and more preferably at least about 100° C., as measured at 66 psi according to the method of ASTM D648. Suitable thermoplastic resins are those with high clarity and include, for example, polyalkyl and aralkyl methacrylate polymers such as polymethyl methacrylate and methacrylate copolymers, styrenic polymers such as polystyrene, polyalkylstyrenes and styrenic copolymers such as styrene-acrylonitrile copolymers and styrene-methyl methacrylate copolymers, olefin-vinyl acetate copolymers, cyclic polyolefins, polymethylpentene, polyolefins such as polyethylene and polypropylene and their copolymers, polyetherimides, polyetherimide sulfones, polysulfones, polyethersulfones, polyphenylene ether sulfones, poly(arylene ether)s, polyglutarimide, polycarbonates, polyester carbonates, polyarylates, and the like, and mixtures thereof. Where necessary to provide the requisite impact resistance, toughened materials may also be employed. These thermoplastics and methods for their preparation are well known in the art.

The scattering particles should be particles with excellent light transmittance and light diffusion properties, and can be preformed particulate structures, including thermoplastic or thermoset resin particles such as alkyl (meth)acrylate-type resins, styrene-type resins, vinyl carboxylate resins and polysiloxane-type resins, and such light diffusing agents may be homopolymers, copolymers or mixtures as well as crosslinked materials and multi-staged polymeric materials. The scattering particles may also comprise mineral, glass or ceramic particles, for example inorganic oxides such as silica, alumina, titanium dioxide, antimony oxide, zirconia, and tungsten oxide, silicate- and aluminosilicate-based minerals or inorganic carbonates. Whichever types of particles are selected, they should have a combination of optical properties (particularly refractive index), particle size, particle size distribution, particle shape and concentration in the matrix which provides the desired scattering properties, resolution and brightness properties. The optimum concentration will depend on the scattering properties required and the refractive index differential between the diffuser particles and the matrix.

At least one other layer in this present invention is a light absorption layer which comprises a polymeric material, preferably an amorphous thermoplastic resin, containing a light absorber to control, as desired, the light transmission through the layer and the frequency, color and contrast properties of the resulting multilayer structure when used in the present multilayer optical device. This said preferably-amorphous thermoplastic resin should have a heat distortion temperature of at least about 70° C., preferably at least about 80° C., and more preferably at least about 100° C., as measured at 66 psi according to ASTM D648. Suitable thermoplastic resins are those with high clarity and include, for example, polyalkyl and aralkyl methacrylate polymers, such as polymethyl methacrylate, and methacrylate copolymers, styrenic polymers such as polystyrene, polyalkylstyrenes and styrenic copolymers such as styrene-acrylonitrile copolymers and styrene-methyl methacrylate copolymers, olefin-vinyl acetate copolymers, cyclic polyolefins, polymethylpentene, polyolefins such as polyethylene and polypropylene, polyetherimides, polyetherimide sulfones, polysulfones, polyethersulfones, polyphenylene ether sulfones, poly(arylene ether)s, polyglutarimide, polycarbonates, polyester carbonates, polyarylates, and the like, and mixtures thereof. Where necessary to provide the requisite impact resistance, toughened materials may also be employed. These thermoplastics and methods for their preparation are well known in the art. The said absorbers include, for example, color and contrast agents which can be soluble or insoluble colored or black dyes or pigments, for example, carbon black, which are commercially available.

A third layer of the device optionally comprises an interfacial layer between the scattering layer and the absorption layer, and can include a separate adhesive layer or a transition zone between the aforesaid two layers resulting from the manufacture of the multilayer system by lamination, coextrusion, solvent bonding, welding or other methods of construction.

The structure may also include one or more protective layers which protect the scattering and absorption layers from physical damage such as scratching or gauging, or may provide a modified surface texture such as a matte, non-reflective, anti-glare, antistatic or embossed surface to enhance the optical or other use properties of the device. The structure may also include one or more layers to focus the light rays or alter their angular direction before the light impinges on the diffuser layer, such as Fresnel, lenticular or other prism structures. In addition, the construction may also include one or more supporting layers to provide improved physical strength, stiffness, resistance to mechanical distortion, temperature resistance or other properties in the optical device. These supporting materials and thicknesses and the matrix materials and thicknesses used for the diffusion and tint layers are selected in combination to provide the requisite physical properties, for example high modulus to provide rigidity for large screens (e.g. 3-4 meters square). For operation in the reflection mode, the device also incorporates one or more reflective layers which may comprise metallized layer(s) or other reflective material(s), for example a metallized mirror type such as a film coated with a reflective material such as silver by sputtering or other suitable processes.

The optical display device of this present invention may be produced by methods such as lamination, co-extrusion, solvent bonding, plastics welding, (co)molding, in situ polymerization such as by ultra-violet or other radiation curing or heat curing techniques, or other suitable fabrication methods which provide a multilayer structure. The shape of the initially-produced multilayer structure can also be subsequently modified and constrained by standard forming methods such as thermoforming and/or by mounting it into a frame which holds it in a particular shape.

In the transmission mode, the light preferably enters from the scattering layer side and is scattered forward to provide a combination of transmission gain (or brightness), resolution and scattering half angle, i.e. the angle from the normal angle to the surface at which the transmission is half that at the normal angle, which is controlled by the composition and processing methods used to make the scattering layer and the scattering layer thickness. The light then passes through into the absorption layer where the frequency characteristics of the light can be modified and the brightness of the image and the contrast controlled by selection of the types and amounts of the dyes or pigments incorporated in the absorption layer. The resulting desired image is then viewed from the absorption layer side.

In the reflection mode, the light preferably enters from the absorption layer side and then passes into the scattering layer and is reflected from the reflection layer placed immediately behind the scattering layer or separated from it by a thin clear or absorbing layer which provides a flat surface for attachment of the reflection layer. The light then passes back through the scattering layer, where it undergoes more scattering and then again through the absorption layer where it undergoes a final modification of frequency, color or contrast properties to provide the final desired image.

The following examples are meant to illustrate aspects of the present invention and some of the ways in which it can be accomplished. Other ways of accomplishing the present invention will be recognized by those skilled in the art given the disclosures herein. The following examples do not limit this present invention, which is set forth in the claims below and extends to all lawful equivalents of the subject matter claimed.

### EXAMPLE 1

A translucent thermoplastic composition containing a scattering species was extruded to produce a film or sheet which scatters polychromatic light at small angles and which acts as a scattering layer in the present invention. This scattering layer comprised a mixture of a commercial acrylic molding resin Atoglas V-826 (Rohm and Haas), which is a methyl methacrylate polymer containing a small amount of copolymerized alkyl acrylate and having a melt flow rate of about 1.6 g/10 min as measured under Condition 1 of ASTM D-1238, and a particulate core-shell modifier (Paraloid EXL 5136; Rohm and Haas). These two components were dry blended and then compounded in a twin screw extruder to produce pellets using a strand die at a melt temperature of about 240° C. These pellets were then dried and extruded at a melt temperature of about 230° C. through an approximately 66-inch wide flat sheet die to produce the scattering film of the present invention.

Compositions of varying ratios of Paraloid and V-826 from 2/98 to 40/70 were prepared and the optical properties determined. The optical properties of the resultant film or sheet were determined by several different methods including light scattering in transmission and reflection modes using Yokogawa or Minolta light meters and an Olympus microscope. Refractive indices were determined with an Abbe refractometer. Optical properties measured included peak gain, viewing angle, resolution, surface reflection and diffuse transmission.

### EXAMPLE 2

A transparent or semi-transparent thermoplastic containing a light absorber was also extruded to produce a film or sheet which absorbs polychromatic light and acts as an absorber layer in this present invention. This absorber film comprises an acrylic molding resin Atoglas DR-101 (Rohm and Haas), which is a methyl methacrylate polymer containing a small amount of copolymerized alkyl acrylate and having a melt flow rate of about 1 g/10 min measured under Condition 1 of ASTM D-1238, and a polymer-soluble black dye (Lambdaplast) in concentrations ranging from 0.07% to 0.003%. These components were dry blended and then compounded in a twin screw extruder to produce pellets using a strand die at a melt temperature of about 240° C. These pellets were then dried and extruded at a melt temperature of about 230° C. through an approximately 66-inch wide flat sheet die to produce the absorber film or sheet of the present invention. The optical properties of the resultant film or sheet were determined as in Example 1.

### EXAMPLE 3

The two thermoplastic compositions used in Examples 1 and 2 were co-extruded to produce a two-layer sheet structure wherein one layer scatters polychromatic light while the second layer absorbs the light and provides contrast. The optical properties of the resultant structure were determined as in Example 1. Results are shown in Table 1.

TABLE 1
Tint layer - DR-101. Tint type: Soluble black dye. Thickness: 0.9 mm
Diffuser layer - V-826. Diffuser type: Paraloid EXL-5136 core-shell
modifier.
Thickness: 0.94 mm

| Tint Conc. % | Diffuser Conc. % | Peak Gain | Half Angle ° |
|---|---|---|---|
| 0.02 | 15 | 2.2 | 19 |

Resolution 5 lines/mm, surface reflection under room ambient light 1.8 cd.mm2.

### COMPARATIVE EXAMPLE 1

A monolayer system was made as described in Example 1 but with the soluble black dye of Example 2 incorporated into the diffusion layer instead of forming a separate layer. This monolayer composition was adjusted to give the same peak gain (2.2) and half angle (19°) as the bilayer structure shown in Example 3 and comprised a 1.84 mm thick layer of V-826 polymethyl methacrylate containing 7.5% Paraloid EXL-5136 diffuser and 0.01% of soluble black dye. Although the peak gain and half-angle properties were matched with the bilayer system of Example 3, the overall optical properties of the monolayer system were far less advantageous since the resolution was now only 3.5 lines/mm (instead of 5 lines/mm) and the surface reflection under room ambient light was 2.6 cd.mm2 (instead of 1.8 cd.mm2) resulting in a much poorer contrast ratio.

### EXAMPLE 4

The two films or sheets of Examples 1 and 2 were bonded together by a lamination process and the optical properties of the resultant structure determined as in Example 1. This gave optical properties essentially undistinguishable from those of Example 3.

### EXAMPLE 5

The two films or sheets of Examples 1 and 2 were bonded together by a solvent bonding process and the optical properties of the resultant structure determined as in Example 1. This gave optical properties essentially undistinguishable from those of Example 3.

### EXAMPLE 6

Example 3 was repeated but using a three layer structure with a tint layer, a diffuser layer and then a clear support layer. The optical properties of the resulting structure were then determined by the methods shown in Example 1. Typical optical results are shown in Table 2.

TABLE 2
Tint layer - OR-101. Tint type: Soluble black dye. Thickness: 0.25 mm
Diffuser layer - V-826. Diffuser type: Paraloid EXL-5136 core-shell
modifier.
Thickness: 2.15 mm
Support layer - DR-101. Thickness: 2.6 mm.

| Tint Conc. % | Diffuser Conc. % | Peak Gain | Half Angle ° |
|---|---|---|---|
| 0.07 | 20 | 1.5 | 27 |

### EXAMPLE 7

Example 4 was repeated using carbon black from Cabot Corporation as the absorbing species instead of the soluble black dye. Much lower brightnesses and peak gain values were obtained than with the soluble black dye used in Example 4.

### EXAMPLE 8

Example 3 was repeated where the diffuser layer and absorption layer thermoplastic matrices comprise Lexan 123 polycarbonate (General Electric Plastics) instead of polymethyl methacrylate. Optical properties were measured as described in Example 1. Advantageous and unusual combinations of gain and half-angle characteristics were noted and typical values are shown in Table 3.

TABLE 3
Tint layer - Lexan 123. Tint type: Soluble black dye. Thickness: 0.9 mm
Diffuser layer - Lexan 123. Diffuser type: Paraloid EXL-5136 core-shell
modifier. Thickness: 1.0 mm

| Tint Conc. % | Diffuser Conc. % | Peak Gain | Half Angle ° |
|---|---|---|---|
| 0.02 | 1.0 | 1.2 | 25 |

### EXAMPLE 9

Example 3 was repeated where the diffuser particles in the diffuser layer comprise Nyasil 6200 silica particles with a mean particle diameter of 1.7 microns . . . Optical properties were measured as described in Example 1. Advantageous and unusual combinations of gain and half-angle characteristics were again noted and typical values are shown in Table 4.

TABLE 4
Tint layer - DR-101. Tint type: Soluble black dye. Thickness: 1.0 mm
Diffuser layer - V-826. Diffuser type: Nyasil 6200 silica. Thickness: 2.0
mm

| Tint Conc. % | Diffuser Conc. % | Peak Gain | Half Angle ° |
|---|---|---|---|
| 0.01 | 10 | 2.7 | 15 |

### EXAMPLE 10

The film or sheet of Example 2 but comprising a copolymer resin consisting of 60% methyl methacrylate and 40% styrene (MS resin TX400 S Natural, Denki Kagaku K.K.) instead of DR-101 was bonded together by a lamination process with a film or sheet equivalent to that of Example 1 but comprising a mixture of this MS Resin and Paraloid EXL-5136, and the optical properties of the resultant structure determined as in Example 1. The results are shown in Table 5 below.

TABLE 5
Tint layer - MS Resin. Tint type: Soluble black dye. Thickness: 0.9 mm
Diffuser layer - MS Resin. Diffuser type: Paraloid EXL-5136 core-shell
modifier.
Thickness: 1.00 mm

| Tint Conc. % | Diffuser Conc. % | Peak Gain | Half Angle ° |
|---|---|---|---|
| 0.020 | 2.5 | 2.1 | 20 |

The invention comprises a multilayer optical device for the visualization of projected light images by transmission or reflection which comprises one or more light-scattering layers, one or more light absorption layers, a reflection layer for use in the reflection mode layers, each layer having a thermoplastic or thermoset matrix and, optionally, one or more interfacial layers, adhesive layers, protective layers, matte, non-reflective, anti-glare, antistatic or embossed surface layers, focusing layers such as Fresnel, lenticular or other prism structures, and supporting layers. The scattering layer or layers may comprise one or more types of thermoplastic film or sheet and the degree and type of scattering in the scattering layers are controlled by the composition, thickness and method of processing of the thermoplastic film or sheet which comprises these layers. Absorption layers may comprise one or more types of thermoplastic film or sheet and the degree and type of absorption in the absorption layers are controlled by the composition, thickness and method of processing of the thermoplastic film or sheet which comprises these layers.

The layers are bonded together by a lamination process, a solvent welding process, a plastics welding process, a molding proces, an injection molding process or a coinjection molding process. The scattering and absorbing layers and optionally other layers can be coextruded to form the multilayer structure. The scattering, absorbing layers, and optionally other layers can be produced by in situ polymerization, by ultra-violet or other radiation curing, or heat curing, to form the multilayer structure.

The thermoplastic matrix used for the scattering or absorbing can be based on polymethyl methacrylate, polystyrene methacrylate copolymers, styrenic copolymers, polycarbonate, polysulfone, cyclic polyolefins, or polymethyl pentene polymers. The scattering layer includes or contains preformed thermoplastic or thermoset particles which control scattering. The particles can be preformed core-shell particles, discrete immiscible glass, mineral, or ceramic particles such as silica which control scattering. The absorbent layer contains a carbon black pigment, or a soluble dye such as a soluble black dye.

The thermoplastic matrix material of the scattering layer and the preformed thermoplastic, thermoset, glass, mineral or ceramic particles dispersed in the matrix of the scattering layer, which control light scattering, have a difference in refractive index in the range of about 0.003 units to about 0.1 units and a particle diameter in the range of about 0.5 micron to about 20 microns.

The volume fraction of the preformed thermoplastic, thermoset, glass, mineral or ceramic particles dispersed in the matrix of the scattering layer, which control light scattering, is generally in the range of about 2% to about 40% and form a stable dispersion in the said matrix material and the particles do not substantially agglomerate during the processing and production of the said scattering layer or said multilayer optical device.

1. A multilayer optical device for the visualization of projected light images by transmission or reflection which comprises one or more light-scattering layers, one or more light absorption layers comprising a light absorber comprising a pigment or dye, a reflection layer for use in the reflection mode, each layer having a thermoplastic or thermoset matrix, and, optionally, one or more interfacial layers, adhesive layers, protective layers, matte, non-reflective, anti-glare, antistatic or embossed surface layers, supporting layers and focusing layers selected from the group consisting of Fresnel, lenticular and other prism structures.

2. A multilayer optical device according to claim 1 for the visualization of projected light images by transmission which comprises one or more light-scattering layers and absorption layers comprising a light absorber comprising a pigment or dye, and optionally one or more interfacial layers, adhesive layers, protective layers, matte, non-reflective, anti-glare, antistatic or embossed surface layers, supporting layers and focusing layers selected from the group consisting of Fresnel, lenticular and other prism structures.

3. A multilayer optical device according to claim 1 for the visualization of projected light images by reflection which comprises one or more light-scattering layers, absorption layers comprising a light absorber comprising a pigment or dye, and reflection layers, and optionally one or more interfacial layers, adhesive layers, protective layers, matte, non-reflective, anti-glare, antistatic or embossed surface layers, supporting layers and focusing layers selected from the group consisting of Fresnel, lenticular and other prism structures.

4. A multilayer optical device of claim 1 in which the scattering layers comprise one or more types of thermoplastic film or sheet and the degree and type of scattering in the scattering layers are controlled by the composition, thickness and method of processing of the thermoplastic film or sheet which comprises these layers.

5. A multilayer optical device of claim 1 in which the absorption layers comprise one or more types of thermoplastic film or sheet and the degree and type of absorption in the absorption layers are controlled by the composition, thickness and method of processing of the thermoplastic film or sheet which comprises these layers.

6. A multilayer optical device of claims 1 in which the layers are bonded together by a lamination process, a solvent welding process, a plastics welding process, a molding process, an injection molding process or a co-injection molding process.

7. A multilayer optical device of claim 1 in which the scattering and absorbing layers and optionally other layers are coextruded to form the multilayer structure.

8. A multilayer optical device of claim 1 in which the scattering, absorbing layers, and optionally other layers are produced by in situ polymerization, by ultra-violet or other radiation curing, or heat curing, to form the multilayer structure.

9. A multilayer optical device of claim 1 in which the thermoplastic matrix used for the scattering or absorbing layers is based on polymethyl methacrylate, polystyrene, methacrylate copolymers, styrenic copolymers, polycarbonates, polysulfones, cyclic polyolefins, or polymethyl pentene polymers.

10. A multilayer optical device of claim 1 in which the scattering layer contains preformed thermoplastic or thermoset particles which control scattering.

11. A multilayer optical device of claim 1 in which the scattering layer contains preformed core-shell particles which control scattering.

12. A multilayer optical device of claim 1 in which the scattering layer contains discrete immiscible glass, mineral, or ceramic particles which control scattering.

13. A multilayer optical device of claim 1 in which the scattering is controlled by discrete immiscible silica particles contained within that layer.

14. A multilayer optical device of claim 1 in which the light absorber comprises a carbon black pigment.

15. A multilayer optical device of claims 1 in which the light absorber comprises a polymer-soluble dye.

16. A multilayer optical device of claim 15 in which the soluble dye is a black dye.

17. A multilayer optical device of claim 1 in which the thermoplastic matrix material of the scattering layer and the preformed thermoplastic, thermoset, glass, mineral or ceramic particles dispersed in the matrix of the scattering layer, which control light scattering, have a difference in refractive index in the range of about 0.003 units to about 0.1 units.

18. A multilayer optical device of claim 1 in which the preformed thermoplastic, thermoset, glass, mineral or ceramic particles dispersed in the matrix of the scattering layer, which control light scattering, have a particle diameter in the range of about 0.5 micron to about 20 microns.

19. A multilayer optical device of claim 1 in which the volume fraction of the preformed thermoplastic, thermoset, glass, mineral or ceramic particles dispersed in the matrix of the scattering layer, which control light scattering, is in the range of about 2% to about 40%.

20. A multilayer optical device of claim 1 in which the preformed thermoplastic, thermoset, glass, mineral or ceramic particles dispersed in the matrix material of the scattering layer, which control light scattering, form a stable dispersion in the said matrix material and the particles do not substantially agglomerate during the processing and production of the said scattering layer or said multilayer optical device.
